(19) United States
(12) Patent Application Publication
(10) Pub. No.: US 2025/0212085 A1
(43) Pub. Date: Jun. 26, 2025

(54) METHOD AND APPARATUS FOR CONDITIONAL HANDOVER

(71) Applicant: Lenovo (Beijing) Limited, Beijing (CN)

(72) Inventors: Lianhai Wu, Beijing (CN); Congchi Zhang, Shanghai (CN); Mingzeng Dai, Shanghai (CN); Le Yan, Shanghai (CN)

(73) Assignee: Lenovo (Beijing) Limited, Beijing (CN)

(21) Appl. No.: 18/848,361

(22) PCT Filed: Jul. 12, 2022
(86) PCT No.: PCT/CN2022/105160

§ 371 Date: Sep. 18, 2024

(51) Int. Cl. H04W 36/36; H04W 74/0833

(52) U.S. Cl. CPC H04W 36/362; H04W 74/0833

(57) ABSTRACT

A method and apparatus for conditional handover (CHO). The method provides a user equipment (UE), including: a processor and a transceiver coupled to the processor, wherein the processor is configured to, via the transceiver, receive at least one of: a CHO configuration for a target master cell group (MCG) and a target secondary cell group (SCG), an execution condition for the target MCG, or an execution condition for the target SCG; and perform a random access (RA) procedure to the target MCG in response to fulfillment of at least the execution condition for the target MCG.

### TECHNICAL FIELD

The present disclosure generally relates to wireless communication technologies, and especially relates to methods and apparatuses for conditional handover (CHO).

### BACKGROUND

A CHO is defined as a handover that is executed by a user equipment (UE) when one or more handover execution conditions are met. The UE starts evaluating the one or more handover execution conditions upon receiving the one or more CHO configurations and one or more CHO execution conditions, and stops evaluating the one or more CHO execution conditions during the CHO execution once the one or more CHO execution conditions are met.

Current wireless communication technology supports a UE simultaneously connecting to two BSs in a dual connectivity (DC) mode, one of the two BSs that connects to a core network is referred to be as a master node (MN), another of the two BSs that does not connect to the core network directly is referred to be as a secondary node (SN). If carrier aggregation (CA) is supported in the network, the cell group of the MN is referred to be as a master cell group (MCG); and the cell group of the SN is referred to be as a secondary cell group (SCG). The MCG includes a primary cell (PCell) and at least one secondary cell (SCell); the SCG includes a secondary primary cell (SpCell) and at least one SCell.

### SUMMARY

Various embodiments and methods of the present disclosure provide solutions related to CHO including MCG and/or SCG.

According to some embodiment of the present disclosure, an exemplary UE is provided. The UE includes: a processor and a transceiver coupled to the processor, wherein the processor is configured to, with the transceiver: receive at least one of: a CHO configuration for a target MCG and a target SCG, a first execution condition for the target MCG, or a second execution condition for the target SCG; and perform a random access (RA) procedure to the target MCG in response to fulfillment of at least the first execution condition.

In some embodiments, the first execution condition for the target MCG includes at least one of: a channel quality threshold, wherein the first execution condition is considered as fulfilled if channel quality is greater than or equal to the channel quality threshold; one conditional event; or a combination of two conditional events.

In some embodiments, the first execution condition includes the combination of the two conditional events, and wherein the processor of the UE is configured to start to evaluate the second execution condition: in response to fulfillment of an entry condition of a first event of the two conditional events; or in response to fulfillment of an entry condition of each of the two conditional events.

In some embodiments, the first execution condition includes the combination of the two conditional events, and wherein the processor of the UE is configured to stop evaluating the second execution condition: in response to fulfillment of a leaving condition of a first event of the two conditional events; or in response to fulfillment of a leaving condition of each of the two conditional events.

In some embodiments, the second execution condition for the target SCG includes at least one of: a channel quality threshold, wherein the second execution condition is considered as fulfilled if channel quality is greater than or equal to the channel quality threshold; one conditional event; a combination of two conditional events; a time range, wherein the time range includes a first absolute time and a second absolute time; or a time threshold and a configuration regarding a timer, wherein the time threshold is a third absolute time.

In some embodiments, the processor of the UE is configured to: start to evaluate the second execution condition in response to fulfillment of the first execution condition; or start to evaluate the second execution condition in responses to fulfillment of an entry condition of the first execution condition; or start to evaluate both the first execution condition and the second execution condition when both the first execution condition and the second execution condition are received.

In some embodiments, the processor of the UE is configured to stop evaluating the second execution condition in response to un-fulfillment of the first execution condition or in response to fulfillment of a leaving condition of the first execution condition.

In some embodiments, the processor of the UE is configured to determine whether the second execution condition is fulfilled: upon completing the RA procedure to the target MCG; or in response to fulfillment of the first execution condition; or in time duration between triggering the RA procedure to the target MCG and completing the RA procedure to the target MCG.

In some embodiments, the second execution condition includes the time range, and wherein the processor of the UE is configured to determine that the second execution condition is fulfilled if a time point when the processor of the UE determines whether the second execution condition is fulfilled is within the time range.

In some embodiments, the second execution condition includes the time threshold and the configuration regarding the timer, and wherein the processor of the UE is configured to: start the timer at time of the time threshold; and determine that the second execution condition is fulfilled if the timer is running at a time point when the processor of the UE determines whether the second execution condition is fulfilled.

In some embodiments, the processor of the UE is configured to: start a mobility timer upon starting to perform the RA procedure to the target MCG and stop the mobility timer upon completing the RA procedure; or in response to fulfillment of both the first execution condition and the second execution condition, perform a RA procedure to the target SCG.

In some embodiments, in response to un-fulfillment of the second execution condition, the processor of the UE is configured to: transmit, with the transceiver, a message including failure information to a target MN; or trigger an SCG failure information procedure.

In some embodiments, the SCG failure information procedure is triggered after completing the RA procedure to the target MCG or a mobility timer is stopped.

In some embodiments, the failure information is included in a radio resource control (RRC) reconfiguration complete message or an SCG failure information message, and wherein the failure information indicates that the second execution condition for the target SCG is not fulfilled.

According to some embodiment of the present disclosure, an exemplary source MN is provided. The source MN includes a processor and a transceiver coupled to the processor, wherein the processor is configured to, with the transceiver: transmit a handover request message to a target MN; receive a handover request acknowledge message from the target MN, wherein the handover request acknowledge message includes a CHO configuration for a target MCG and a target SCG; and transmit, to a UE, at least one of: the CHO configuration for the target MCG and the target SCG, a first execution condition for the target MCG, or a second execution condition for the target SCG.

In some embodiments, the handover request acknowledge message includes an indicator indicating that the CHO configuration includes configuration information for the target SCG, e.g., RRC configuration information for the target SCG.

In some embodiments, the processor of the source MN is further configured to configure the second execution condition for the target SCG in response to that the indicator is received.

In some embodiments, the handover request acknowledge message includes the second execution condition for the target SCG.

In some embodiments, the second execution condition for the target SCG is generated by the target MN.

In some embodiments, the first execution condition for the target MCG includes at least one of: a channel quality threshold, wherein the first execution condition is considered as fulfilled if channel quality is greater than or equal to the channel quality threshold; one conditional event; or a combination of two conditional events.

In some embodiments, the second execution condition for the target SCG includes at least one of: a channel quality threshold, wherein the second execution condition is considered as fulfilled if channel quality is greater than or equal to the channel quality threshold; one conditional event; a combination of two conditional events; a time range, wherein the time range includes a first absolute time and a second absolute time; or a time threshold and a configuration regarding a timer, wherein the time threshold is a third absolute time.

According to some embodiment of the present disclosure, an exemplary target MN is provided. The target MN includes a processor and a transceiver coupled to the processor, wherein the processor is configured to, with the transceiver: receive a handover request message from a source MN; and transmit a handover request acknowledge message to the source MN, wherein the handover request acknowledge message includes a CHO configuration for a target MCG and a target SCG.

In some embodiments, the processor of the target MN is configured to receive, with the transceiver, failure information from the UE, and wherein the failure information indicates that the second execution condition for the target SCG is not fulfilled.

In some embodiments, the failure information is received upon the UE completing a RA procedure to the target MCG.

In some embodiments, the failure information is included in an SCG failure information message or via an RRC reconfiguration complete message.

In some embodiments, the processor of the target MN is configured to transfer the received failure information to the source MN.

In some embodiments, the handover request acknowledge message further includes one of: a second execution condition for the target SCG; or an indicator for indicating the source MN to configure the second execution condition.

In some embodiments, the processor of the target MN is configured to: transmit an indicator to a target secondary node (SN) via a request message, wherein the indicator indicates the target SN to configure the second execution condition; and receive the second execution condition from the target SN.

In some embodiments, the second execution condition includes at least one of: a channel quality threshold, wherein the second execution condition is considered as fulfilled if channel quality is greater than or equal to the channel quality threshold; one conditional event; a combination of two conditional events; a time range, wherein the time range includes a first absolute time and a second absolute time; or a time threshold and a configuration regarding a timer, wherein the time threshold is a third absolute time.

In some embodiments, the processor of the target MN is configured to receive an acknowledge message from a target SN, and wherein the acknowledge message includes configuration information for the target SCG, e.g., RRC configuration information for the target SCG.

According to some embodiment of the present disclosure, an exemplary target SN is provided. The target SN includes a processor and a transceiver coupled to the processor, wherein the processor is configured to, with the transceiver: receive a request message from a target MN; and transmit an acknowledge message to the target MN, wherein the acknowledge message includes configuration information for a target SCG, e.g., RRC configuration information for the target SCG.

In some embodiments, the request message includes an indication indicating the target SN to configure an execution condition for the target SCG.

In some embodiments, the processor of the target SN is configured to transmit, with the transceiver, the execution condition for the target SCG to the target MN.

In some embodiments, the execution condition for the target SCG includes at least one of: a channel quality threshold, wherein the execution condition for the target SCG is considered as fulfilled if channel quality is greater than or equal to the channel quality threshold; one conditional event; a combination of two conditional events; a time range, wherein the time range includes a first absolute time and a second absolute time; or a time threshold and a configuration regarding a timer, wherein the time threshold is a third absolute time.

According to some embodiments of the present disclosure, an exemplary method performed by a UE is provided. The method includes: receiving at least one of: a CHO configuration for a target MCG and a target SCG, a first execution condition for the target MCG, or a second execution condition for the target SCG; and performing a RA procedure to the target MCG in response to fulfillment of at least the first execution condition.

In some embodiments, the first execution condition for the target MCG includes at least one of: a channel quality threshold, wherein the first execution condition is considered as fulfilled if channel quality is greater than or equal to the channel quality threshold; one conditional event; or a combination of two conditional events.

In some embodiments, the first execution condition includes the combination of the two conditional events, and wherein the method includes starting to evaluate the second execution condition: in response to fulfillment of an entry condition of a first event of the two conditional events; or in response to fulfillment of an entry condition of each of the two conditional events.

In some embodiments, the first execution condition includes the combination of the two conditional events, and wherein the method includes stopping evaluating the second execution condition: in response to fulfillment of a leaving condition of a first event of the two conditional events; or in response to fulfillment of a leaving condition of each of the two conditional events.

In some embodiments, the second execution condition for the target SCG includes at least one of: a channel quality threshold, wherein the second execution condition is considered as fulfilled if channel quality is greater than or equal to the channel quality threshold; one conditional event; a combination of two conditional events; a time range, wherein the time range includes a first absolute time and a second absolute time; or a time threshold and a configuration regarding a timer, wherein the time threshold is a third absolute time.

In some embodiments, the method includes: starting to evaluate the second execution condition in response to fulfillment of the first execution condition; or starting to evaluate the second execution condition in responses to fulfillment of an entry condition of the first execution condition; or starting to evaluate both the first execution condition and the second execution condition when both the first execution condition and the second execution condition are received.

In some embodiments, the method includes stopping evaluating the second execution condition in response to un-fulfillment of the first execution condition or in response to fulfillment of a leaving condition of the first execution condition.

In some embodiments, the method includes determining whether the second execution condition is fulfilled: upon completing the RA procedure to the target MCG; or in response to fulfillment of the first execution condition; or in time duration between triggering the RA procedure to the target MCG and completing the RA procedure to the target MCG.

In some embodiments, the second execution condition includes the time range, and wherein the method includes determining that the second execution condition is fulfilled if a time point when the UE determines whether the second execution condition is fulfilled is within the time range.

In some embodiments, the second execution condition includes the time threshold and the configuration regarding the timer, and wherein the method includes: starting the timer at time of the time threshold; and determining that the second execution condition is fulfilled if the timer is running at a time point when the UE determines whether the second execution condition is fulfilled.

In some embodiments, wherein: the method further includes: starting a mobility timer upon starting to perform the RA procedure to the target MCG and stopping the mobility timer upon completing the RA procedure; or in response to fulfillment of both the first execution condition and the second execution condition, performing a RA procedure to the target SCG.

In some embodiments, in response to un-fulfillment of the second execution condition, the method includes: transmitting a message including failure information to a target master node (MN); or triggering an SCG failure information procedure.

In some embodiments, the SCG failure information procedure is triggered after completing the RA procedure to the target MCG or a mobility timer is stopped.

In some embodiments, the failure information is included in an RRC reconfiguration complete message or an SCG failure information message, and wherein the failure information indicates that the second execution condition for the target SCG is not fulfilled.

According to some embodiments of the present disclosure, an exemplary method performed by a source MN is provided. The method includes: transmitting a handover request message to a target MN; receiving a handover request acknowledge message from the target MN, wherein the handover request acknowledge message includes a CHO configuration for a target MCG and a target SCG; and transmitting, to a UE, at least one of the CHO configuration for the target MCG and the target SCG, a first execution condition for the target MCG, or a second execution condition for the target SCG.

In some embodiments, the handover request acknowledge message includes an indicator indicating that the CHO configuration includes configuration information for the target SCG, e.g., RRC configuration information for the target SCG.

In some embodiments, the method further includes configuring the second execution condition for the target SCG in response to that the indicator is received.

In some embodiments, the handover request acknowledge message includes the second execution condition for the target SCG.

In some embodiments, the second execution condition for the target SCG is generated by the target MN.

In some embodiments, the first execution condition for the target MCG includes at least one of: a channel quality threshold, wherein the first execution condition is considered as fulfilled if channel quality is greater than or equal to the channel quality threshold; one conditional event; or a combination of two conditional events.

In some embodiments, the second execution condition for the target SCG includes at least one of: a channel quality threshold, wherein the second execution condition is considered as fulfilled if channel quality is greater than or equal to the channel quality threshold; one conditional event; a combination of two conditional events; a time range, wherein the time range includes a first absolute time and a second absolute time; or a time threshold and a configuration regarding a timer, wherein the time threshold is a third absolute time.

According to some embodiments of the present disclosure, an exemplary method performed by a target MN is provided. The method includes: receiving a handover request message from a source MN; and transmitting a handover request acknowledge message to the source MN, wherein the handover request acknowledge message includes a CHO configuration for a target MCG and a target SCG.

In some embodiments, the method includes receiving failure information from the UE, and wherein the failure information indicates that the second execution condition for the target SCG is not fulfilled.

In some embodiments, the failure information is received upon the UE completing a RA procedure to the target MCG.

In some embodiments, the failure information is included in an SCG failure information message or via an RRC reconfiguration complete message.

In some embodiments, the method includes transferring the received failure information to the source MN.

In some embodiments, the handover request acknowledge message further includes one of: a second execution condition for the target SCG; or an indicator for indicating the source MN to configure the second execution condition.

In some embodiments, the method includes: transmitting an indicator to a target SN via a request message, wherein the indicator indicates the target SN to configure the second execution condition; and receiving the second execution condition from the target SN.

In some embodiments, the second execution condition includes at least one of: a channel quality threshold, wherein the second execution condition is considered as fulfilled if channel quality is greater than or equal to the channel quality threshold; one conditional event; a combination of two conditional events; a time range, wherein the time range includes a first absolute time and a second absolute time; or a time threshold and a configuration regarding a timer, wherein the time threshold is a third absolute time.

In some embodiments, the method includes receiving an acknowledge message from a target SN, and wherein the acknowledge message includes configuration information for the target SCG, e.g., RRC configuration information for the target SCG.

According to some embodiments of the present disclosure, an exemplary method performed by a target SN is provided. The method includes: receive a request message from a target MN; and transmit an acknowledge message to the target MN, wherein the acknowledge message includes configuration information for a target SCG, e.g., RRC configuration information for the target SCG.

In some embodiments, the request message includes an indication indicating the target SN to configure an execution condition for the target SCG.

In some embodiments, the method includes transmitting the execution condition for the target SCG to the target MN.

In some embodiments, the execution condition for the target SCG includes at least one of: a channel quality threshold, wherein the execution condition for the target SCG is considered as fulfilled if channel quality is greater than or equal to the channel quality threshold; one conditional event; a combination of two conditional events; a time range, wherein the time range includes a first absolute time and a second absolute time; or a time threshold and a configuration regarding a timer, wherein the time threshold is a third absolute time.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates an exemplary flowchart of a method performed by a UE according to some embodiments of the present disclosure.

FIG. 2 illustrates an exemplary flowchart of a method performed by a source MN according to some embodiments of the present disclosure.

FIG. 3 illustrates an exemplary flowchart of a method performed by a target MN according to some embodiments of the present disclosure.

FIG. 4 illustrates an exemplary flowchart of a method performed by a target SN according to some embodiments of the present disclosure.

FIGS. 5 and 6 illustrate exemplary signaling flowcharts according to some embodiments of the present disclosure.

FIG. 7 illustrates a simplified block diagram of an exemplary apparatus according to some embodiments of the present disclosure.

### DETAILED DESCRIPTION

The detailed description of the appended drawings is intended as a description of some embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

While operations are depicted in the drawings in a particular order, persons skilled in the art will readily recognize that such operations need not be performed in the particular order shown or in sequential order, or that among all illustrated operations be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP 5G new radio (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

In general, one or more CHO configurations contain the configurations for CHO candidate cell(s) generated by the candidate base station(s) (BS) (s), and the one or more CHO execution conditions are generated by the source BS after receiving acknowledgement from the candidate BS; an execution condition may consist of one or two trigger conditional events (e.g., conditional events A3, A4, A5, B1, and/or B2 as specified in 3GPP standard document TS38.331). Only a single reference signal (RS) type is supported and at most two different execution quantities (e.g., reference signal received power (RSRP) and reference signal Received quality (RSRQ), RSRP and signal to interference plus noise ratio (SINR), etc.) can be configured simultaneously for the evaluation of a CHO execution condition of a single candidate cell.

A CHO is executed by a UE when one or more handover execution conditions are met. A UE starts evaluating the execution condition(s) upon receiving the CHO configuration, and stops evaluating the execution condition during the CHO execution once the execution condition(s) is met. A CHO configuration contains the configuration for CHO candidate cell(s) generated by the candidate BS(s) and execution condition(s) generated by the source BS.

As in an intra-NR RAN handover, or in intra-NR radio access network (RAN) CHO, the preparation and execution phase of the CHO procedure is performed without involvement of the 5G Core Network (5GC); i.e., preparation messages are directly exchanged between BSs. The release of the resources at the source BS during the conditional handover completion phase is triggered by the target BS, wherein neither the access and mobility management function (AMF) nor the user plane function UPF changes.

Currently, an inter-MN handover with or without MN initiated SN change is used to transfer UE context data from a source MN to a target MN while the UE context at the SN is kept or moved to another SN. During an Inter-MN handover, the target MN decides whether to keep or change the SN (or release the SN). Only intra radio access technology (intra-RAT) Inter-MN handover with or without SN change is supported.

In some cases, an M-NG-RAN node initiates the procedure by sending the S-NODE ADDITION REQUEST message to the S-NG-RAN node. If the CHO Information SN Addition IE is included in the S-NODE ADDITION REQUEST message, the S-NG-RAN node shall consider that the S-NG-RAN node Addition Preparation procedure has been triggered as part of a conditional handover. It may use the Source M-NG-RAN node ID IE and the Source M-NG-RAN node UE XnAP ID IE to identify other active S-NG-RAN node Addition Preparations related to this UE. If the Estimated Arrival Probability IE is contained in the CHO Information SN Addition IE included in the S-NODE ADDITION REQUEST message, the S-NG-RAN node may use the information to allocate necessary resources for the UE.

In some other cases, an M-NG-RAN node initiates the procedure by sending the S-NODE MODIFICATION REQUEST message to the S-NG-RAN node. If the CHO Information SN Modification IE is included in the S-NODE MODIFICATION REQUEST message, the S-NG-RAN node shall consider that the M-NG-RAN node initiated S-NG-RAN node Modification Preparation procedure has been triggered as part of a conditional handover. If the Estimated Arrival Probability IE is contained in the CHO Information SN Modification IE included in the S-NODE MODIFICATION REQUEST message, the S-NG-RAN node may use the information to allocate necessary resources for the UE.

In general, there is a scenario of CHO including different SCGs in which a UE performs a CHO from a source PCell with a source SCG to a target PCell with a target SCG, or a scenario of CHO from single-connectivity to an (MR-) DC connection in which a UE performs a CHO from a source cell to a target PCell with a target SCG. In above two scenarios, it is possible that the target SCG is not available when the execution condition(s) for CHO is met. However, such issues have not been solved. Embodiments of the present disclosure aim to solve these issues in the abovementioned scenarios. Some embodiments of the present disclosure provide solutions so as to ensure that a target SCG is available when the UE performs a CHO including SCG.

For example, according to some embodiments of the present disclosure, methods and corresponding apparatuses (e.g., a UE, a source MN, a target MN, and a target SN) are provided for ensure success of a CHO including SCG by adding an addition execution condition for CHO including SCG (i.e., the execution condition for the target SCG). The additional condition may be, e.g., S-criteria, one or two conditional events, a time range, or a time threshold and an associated timer.

Some embodiments of the present disclosure introduce a mechanism for a time point of beginning to evaluate the target SCG or the execution condition for the target SCG (i.e., the execution condition for the target SCG) in the case of CHO including SCG.

Some embodiments of the present disclosure introduce a mechanism for a time point of determining whether the execution condition for SCG is met. Some embodiments of the present disclosure design when, where, and how to report the failure information if the CHO including SCG is failed.

According to some embodiments of the present disclosure, a MN or an SN may be referred to be as an access point, an access terminal, a base, a macro cell, a RAN node, a next generation (NG) RAN node, a node-B, an enhanced node B (eNB), a gNB, a home node-B, a relay node, or a device, or described using other terminology used in the art. The MN or the SN is generally part of a RAN that may include a controller communicably coupled to it.

According to some embodiments of the present disclosure, a UE may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art. According to some embodiments of the present disclosure, the UE is configured to support DC.

According to some embodiments of the present disclosure, a wireless communication system supports DC or non-standalone (NSA) mode. The wireless communication system is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks. The present disclosure is not intended to be limited to the implementation of any particular wireless communication system architecture or protocol.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

FIG. 1 illustrates an exemplary flowchart of method 100 performed by a UE configured with DC function according to some embodiments of the present disclosure. As illustrated in FIG. 1, method 100 includes two operations: operation 110 and operation 120.

In operation 110, the UE receives, e.g., from a source MN, at least one of: a CHO configuration for a target MCG and a target SCG, an execution condition for the target MCG, or an execution condition for the target SCG. In some embodiments, the CHO configuration includes at least one of: configuration information for the target MCG, or configuration information for the target SCG.

In operation 120, the UE performs a RA procedure to the target MCG in response to that at least the execution condition for the target MCG is fulfilled.

According to some embodiments of the present disclosure, the execution condition for the target MCG includes at least one of:
(1) A channel quality threshold. In an embodiment, the execution condition for the target MCG is considered as fulfilled if channel quality is greater than or equal to the channel quality threshold. For example, the channel quality threshold is S-criteria as specified in 3GPP standard document TS38.304.
(2) One conditional event. In some embodiments, the conditional event may be one of conditional events A3, A4, A5, B1, and/or B2 as specified in 3GPP standard document TS38.331.
(3) A combination of two conditional events. In some embodiments, the combination of the two conditional events may be conditional events A3 and A5.

According to some embodiments of the present disclosure, the execution condition for the target SCG includes at least one of:
(1) a channel quality threshold, in some embodiments, the execution condition for the target SCG is considered as fulfilled if channel quality is greater than or equal to the channel quality threshold; for example, the channel quality threshold is S-criteria;
(2) one conditional event; for example, the conditional event may be one of conditional events A3, A4, A5, B1, and/or B2;
(3) a combination of two conditional events; in some embodiments, the combination of the two conditional events may be conditional events A3 and A5;
(4) a time range, wherein the time range includes a first absolute time and a second absolute time; in some embodiments, the first absolute time and the second absolute time may be universal time coordinated (UTC) time; or
(5) a time threshold and a configuration regarding a timer. In some embodiments, the time threshold is a third absolute time. For example, the third absolute time may be UTC time. The configuration regarding the timer may include a length of the timer.

In some embodiments, the UE starts to evaluate the execution condition for the target SCG if the execution condition for the target MCG is fulfilled, and stops evaluating the execution condition for the target SCG if the execution condition for the target MCG is not fulfilled.

In some embodiments, the UE start to evaluate both the execution condition for the target MCG and the execution condition for the target SCG when both the execution condition for the target MCG and the execution condition for the target SCG are received.

In some embodiments, the execution condition for the target MCG includes one conditional event (e.g., conditional event A3, A4, A5, B1, or B2), the UE starts to evaluate the execution condition for the target SCG if an entry condition of the one conditional event is fulfilled, and stops evaluating the execution condition for the target SCG if a leaving condition of the one conditional events is fulfilled.

In some embodiments, the execution condition for the target MCG includes a combination of two conditional events (e.g., conditional events A3 and A5), the UE starts to evaluate the execution condition for the target SCG if an entry condition of one event of these two conditional events of the execution condition for the target MCG is fulfilled, and stops evaluating the execution condition for the target SCG if a leaving condition of the one event of these two conditional events of the execution condition for the target MCG is fulfilled.

In some embodiments, the execution condition for the target MCG includes a combination of two conditional events (e.g., conditional events A3 and A5), the UE starts to evaluate the execution condition for the target SCG if an entry condition of each of the two conditional events of the execution condition for the target MCG is fulfilled, and stops evaluating the execution condition for the target SCG if a leaving condition of each of the two conditional events of the execution condition for the target MCG is fulfilled.

In some embodiments, the UE determines whether the execution condition for the target SCG is fulfilled when the UE completes the RA procedure to the target MCG.

In some further embodiments, the UE determines whether the execution condition for the target SCG is fulfilled when the execution condition for the target MCG is fulfilled.

In some other embodiments, the UE determines whether the execution condition for the target SCG is fulfilled in time duration between “triggering the RA procedure to the target MCG” and “completing the RA procedure to the target MCG”.

In some embodiments, the execution condition for the target SCG includes a time range, the UE determines that the execution condition for the target SCG is fulfilled if “the time point when the UE makes the determination whether the execution condition for the target SCG is fulfilled” is within the time range.

In some embodiments, the execution condition for the target SCG includes a time threshold and a configuration regarding the timer, the UE starts the timer at time of the time threshold. If the timer is still running at the time point when the UE makes the determination whether the execution condition for the target SCG is fulfilled, the UE determines that the execution condition for the target SCG is fulfilled.

In some embodiments, in operation 120, the UE performs the RA procedure to the target MCG when the execution condition for the target MCG is fulfilled. For example, the UE may start a mobility timer (e.g., timer T304 as specified in 3GPP standard document) upon starting to perform the RA procedure to the target MCG, and stop the mobility timer upon completing the RA procedure to the target MCG.

In some embodiments, in operation 120, the UE performs the RA procedure to the target MCG when both the execution condition for the target MCG and the execution condition for the target SCG are fulfilled. For example, the UE may start a mobility timer when the RA procedure to the target MCG is started, and the UE may stop the mobility timer upon completing the RA procedure to the target MCG.

In some embodiments, if the UE determines that the execution condition for the target SCG is not fulfilled, the UE may transmit a message including failure information to a target MN. In an embodiment, the failure information is included in an RRC reconfiguration complete message or an SCG failure information message; wherein the failure information indicates that the execution condition for the target SCG is not fulfilled.

In some embodiments, if the UE determines that the execution condition for the target SCG is not fulfilled, the UE may trigger an SCG failure information procedure. In an embodiment, the SCG failure information procedure is triggered after the RA procedure to the target MCG is completed or the mobility timer (e.g., timer T304) is stopped.

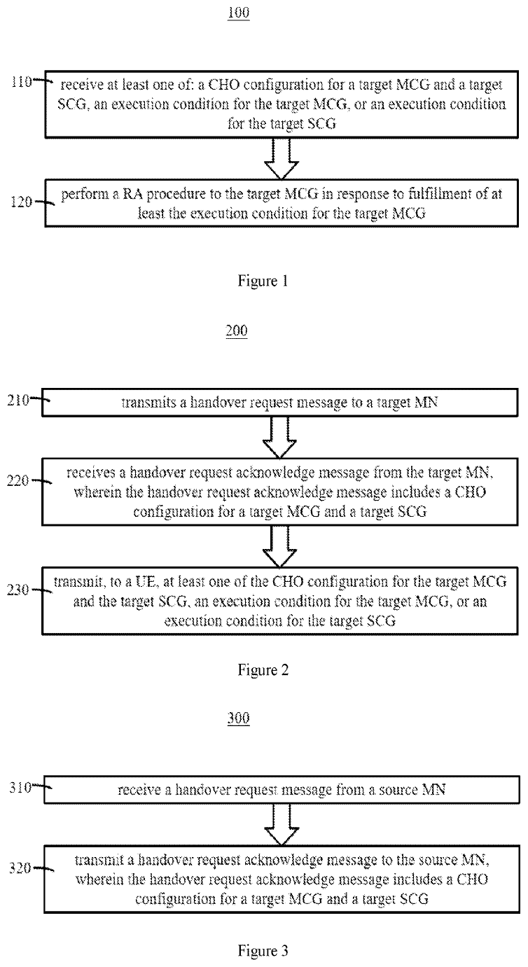

FIG. 2 illustrates an exemplary flowchart of method 200 performed by a source MN according to some embodiments of the present disclosure. As illustrated in FIG. 2, method 200 includes three operations: operation 210, operation 220, and operation 230.

In operation 210, the source MN transmits a handover request message to a target MN. In some embodiments, based on the measurement results from a UE, the source MN may determine to switch the UE to a target MN via CHO. Then, the source MN may transmit a handover request message to the target MN to indicate the target MN to prepare a target SCG or a target SN.

In operation 220, the source MN receives a handover request acknowledge message from the target MN, e.g., via Xn interface. The handover request acknowledge message includes a CHO configuration for a target MCG and a target SCG. In some embodiments, the CHO configuration for the target MCG and the target SCG includes at least one of: configuration information for the target MCG, or configuration information for the target SCG.

In operation 230, the source MN transmits, to a UE, at least one of: the CHO configuration for the target MCG and the target SCG, an execution condition for the target MCG, or an execution condition for the target SCG.

In some embodiments, the source MN configures the execution condition for the target MCG. In some embodiments, the execution condition for the target MCG includes at least one of:
(1) a channel quality threshold, wherein the execution condition for the target MCG is considered as fulfilled if channel quality is greater than or equal to the channel quality threshold;
(2) one conditional event, e.g., conditional event A3, A4, A5, B1, or B2; or
(3) a combination of two conditional events, e.g., conditional events A3 and A5.

In some embodiments, the handover request acknowledge message includes an indicator. The indicator indicates that the CHO configuration includes configuration information for the target SCG, e.g., RRC configuration information for the target SCG. In an embodiment, upon receiving the indicator, the source MN configures the execution condition for the target SCG.

In some embodiments, the target MN generates the execution condition for the target SCG, and sends the generated execution condition for the target SCG to the source MN via the handover request acknowledge message; i.e., the handover request acknowledge message transmitted from the target MN to the source MN includes the execution condition for the target SCG.

In some embodiments, the execution condition for the target SCG includes at least one of:
(1) a channel quality threshold, wherein the execution condition for the target SCG is considered as fulfilled if channel quality is greater than or equal to the channel quality threshold;
(2) one conditional event, e.g., conditional event A3, A4, A5, B1, or B2;
(3) a combination of two conditional events, e.g., conditional events A3 and A5;
(4) a time range, wherein the time range includes a first absolute time and a second absolute time, e.g., UTC time; or
(5) a time threshold and a configuration regarding a timer, wherein the time threshold is a third absolute time, e.g., UTC time.

FIG. 3 illustrates an exemplary flowchart of method 300 performed by a target MN according to some embodiments of the present disclosure. As illustrated in FIG. 3, method 300 includes two operations: operation 310 and operation 320.

In operation 310, the target MN receives a handover request message from a source MN. In some embodiments, the handover request message indicates the target MN to prepare a target SCG or a target SN due to that the source MN determines to switch a UE to the target MN via CHO.

In operation 320, the target MN transmits a handover request acknowledge message to the source MN, e.g., via Xn interface. The handover request acknowledge message includes a CHO configuration for a target MCG and a target SCG. The CHO configuration may include at least one of: configuration information for the target MCG, or configuration information for the target SCG. In some embodiments, the target MN generates the configuration information for the target MCG. In some other embodiments, the target MN generates the configuration information for the target SCG. In some embodiments, the target MN may request the target SCG to provide the configuration information for the target SCG, e.g., via a request message, and receive the configuration information for the target SCG from the target SN, e.g., via an acknowledge message.

In some embodiments, the handover request acknowledge message includes an indicator for indicating the source MN to configure the execution condition for the target SCG itself. Specifically, when the source MN receives such indicator, the source MN will configure the execution condition for the target SCG.

In some embodiments, after reception of the handover request message from the source MN, the target MN generates the execution condition for the target SCG. In some embodiments, after reception of the handover request message from the source MN, the target MN transmits an indicator to a target SN, e.g., via a request message (e.g., SgNB Addition Request, SN Modification request message), to indicate the target SN to configure the execution condition for the target SCG, and receives the execution condition for the target SCG from the target SN. In some embodiments, the handover request acknowledge message includes the execution condition for the target SCG.

In some embodiments, the execution condition for the target SCG includes at least one of:
(1) a channel quality threshold, wherein the execution condition for the target SCG is considered as fulfilled if channel quality is greater than or equal to the channel quality threshold;
(2) one conditional event, e.g., conditional event A3, A4, A5, B1, or B2;
(3) a combination of two conditional events, e.g., conditional events A3 and A5;
(4) a time range, wherein the time range includes a first absolute time and a second absolute time, e.g., UTC time; or
(5) a time threshold and a configuration regarding a timer, wherein the time threshold is a third absolute time, e.g., UTC time.

In some embodiments, the target MN may receive failure information from the UE. The failure information indicates that the execution condition for the target SCG is not fulfilled. In some embodiments, the target MN may receive the failure information upon the UE completing a RA procedure to the target MCG. For example, if the UE accesses to the target MN (i.e., the RA procedure to the target MCG succeeds) while the execution condition for the target SCG is not fulfilled for the UE, or if the UE fails to access to the target MN, the UE may transmit the failure information to the target MN. In some embodiments, the target MN may receive the failure information via an RRC reconfiguration complete message. In some other embodiments, the target MN may receive the failure information via an SCG failure information message.

In some embodiments, if the target MN receives failure information from the UE, the target MN may transfer or forward the received failure information to the source MN. One advantage is to enhance mobility robustness optimization (MRO) function of the wireless communication system. For example, upon reception of this usable information (i.e., the received failure information), the wireless communication system is able to analyze whether its mobility configuration needs adjustment; such adjustments may result in changes of mobility configurations, such as changes of Radio Link Management (RLM) configurations or changes of mobility thresholds between a source node and a target node.

FIG. 4 illustrates an exemplary flowchart of method 400 performed by a target SN according to some embodiments of the present disclosure. As illustrated in FIG. 4, method 400 includes two operations: operation 410 and operation 420.

In operation 410, the target SN receives a request message from a target MN. In some embodiments, the request message indicates the target SN to provide configuration information for the target SCG.

In operation 420, the target SN transmits an acknowledge message to the target MN. The acknowledge message includes configuration information for the target SCG, e.g., RRC configuration information for the target SCG.

In some embodiment, the request message from the target MN also includes an indication to indicate the target SN to configure the execution condition for the target SCG. After receiving the request message, the target SN configures and transmits the execution condition for the target SCG to the target MN.

In some embodiment, the execution condition for the target SCG includes at least one of:
(1) a channel quality threshold, wherein the execution condition for the target SCG is considered as fulfilled if channel quality is greater than or equal to the channel quality threshold;
(2) one conditional event, e.g., conditional event A3, A4, A5, B1, or B2;
(3) a combination of two conditional events, e.g., conditional events A3 and A5;
(4) a time range, wherein the time range includes a first absolute time and a second absolute time, e.g., UTC time; or
(5) a time threshold and a configuration regarding a timer, wherein the time threshold is a third absolute time, e.g., UTC time.

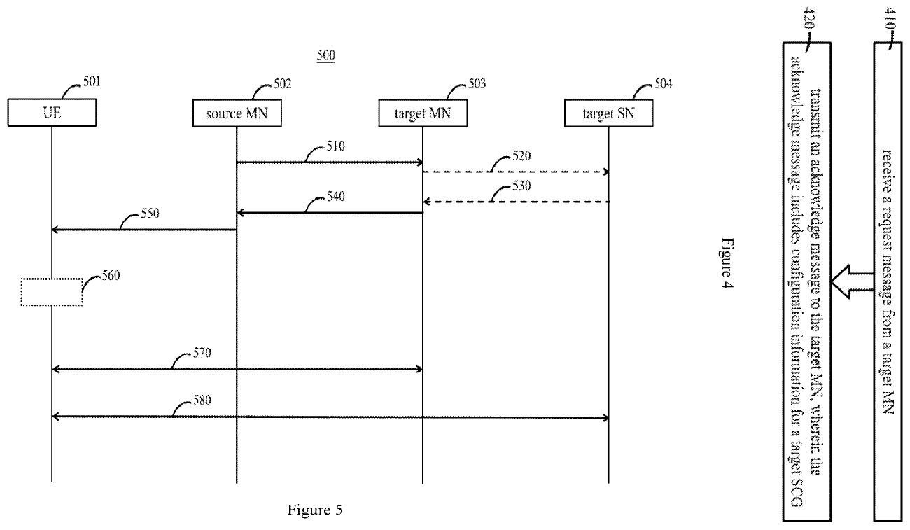

FIG. 5 illustrates an exemplary signaling flow chart 500 according to some embodiments of the present disclosure. It would be appreciated that for simplification and concise, FIG. 5 only illustrates necessary signaling according to some embodiments of the present disclosure, and the present disclosure is not limited to the exemplary flow chart 500. In the embodiments of FIG. 5, the wireless communication system may support DC or non-standalone (NSA) mode.

In the embodiments of FIG. 5, UE 501 in an RRC connected state accesses its serving BS, e.g., source MN 502. UE 501 may report measurement results to source MN 502. Based on the received measurement results, source MN 502 may determine to switch UE 501 to target MN 503 via CHO including SCG. For example, source MN 502 may prepare an execution condition for the target MCG.

In operation 510, source MN 502 transmits a handover request message to target MN 503. The handover request message may indicate target MN 503 to prepare a target SCG, e.g., target SN 504.

In some embodiments, after reception of the handover request message, target MN 503 may prepare configuration information for the target MCG. In an embodiment, in operation 520, target MN 503 transmits a request message (e.g., SgNB Addition Request or SN Modification request message) to target SN 504, e.g., via Xn interface, and in operation 530, target SN 504 transmits configuration information for the target MCG to target MN 503 via an acknowledge message (e.g., SgNB Addition Request Acknowledge or SgNB modification Request Acknowledge).

In some embodiments, target MN 503 prepares the execution condition for the target SCG. In an embodiment, in operation 520, target MN 503 transmits a request message (e.g., SgNB Addition Request or SN Modification request message) to target SN 504, e.g., via Xn interface, and in operation 530, target SN 504 transmits the execution condition for the target SCG to target MN 503 via an acknowledge message (e.g., SgNB Addition Request Acknowledge or SgNB modification Request Acknowledge).

operation 5 operation 5 In some embodiments, if the CHO Information SN Addition IE is included in the request message in operation 520, target SN 504 shall consider that the SN (S-NG-RAN node) Addition Preparation procedure has been triggered as part of a conditional handover. It may use the Source M-NG-RAN node ID IE and the Source M-NG-RAN node UE XnAP ID IE to identify other active S-NG-RAN node Addition Preparations related to UE 501.

In some embodiments, if the Estimated Arrival Probability IE is contained in the CHO Information SN Addition IE included in the request message in operation 520, the S-NG-RAN node may use the information to allocate necessary resources for UE 501.

Operation 520 and 530 are optional in the embodiments of FIG. 5 and thus are marked as dotted lines in FIG. 5.

Then, in operation 540, target MN 503 transmits a handover request acknowledge message to source MN 502, e.g., via Xn interface. The handover request acknowledge message includes a CHO configuration for the target MCG and the target SCG. The CHO configuration for the target MCG and the target SCG include configuration information for the target MCG and configuration information for the target SCG.

In some embodiments, the handover request acknowledge message in operation 540 includes an execution condition for the target SCG. The execution condition for the target SCG may be generated by target MN 503 or received from target SN 504. That is, in these embodiments, target MN 503 configures the execution condition for the target SCG together with CHO configuration. When UE 501 receives CHO including the target SCG, UE 501 is expected to decode the CHO command. For instance, the execution condition for the target SCG could be S-criteria, conditional event A3 or A5, a time range, and/or a time threshold and a configuration regarding a timer as described above in any of the embodiments of FIGS. 1-4.

In some other embodiments, the handover request acknowledge message in operation 540 includes an indicator indicating that the CHO configuration includes configuration information for the target SCG, e.g., RRC configuration information for the target SCG. This indicator may be used to indicate source MN 502 to configure the execution condition for the target SCG. That is, in these embodiments, source MN 502 configures the execution condition for the target SCG. One explicit indication is added in the handover request acknowledge message in operation 540, to indicate that SCG is added in RRC reconfiguration for CHO.

Then in operation 550, source MN 502 transmits at least one of: the CHO configuration for the target MCG and the target SCG, the execution condition for the target MCG, or the execution condition for the target SCG to UE 501, e.g., via an RRC reconfiguration message for CHO including SCG. The execution condition for the target SCG is received from target MN 503 or is generated by source MN 502 itself.

Then, in operation 560, UE 501 begins to evaluate the execution condition for the target MCG and the execution condition for the target SCG, and determines whether the execution condition for the target MCG and the execution condition for the target SCG are fulfilled. The present disclosure has provided various methods and embodiments regarding how and when to evaluate the execution condition for the target MCG and/or the execution condition for the target SCG, and regarding determining whether the execution condition for the target MCG and/or the execution condition for the target SCG is fulfilled, e.g., in any of the embodiments of FIGS. 1-4.

For example, in operation 560, UE 501 may evaluate the execution condition for the target MCG when receiving the RRC reconfiguration message for CHO including SCG. Operation 560 is optional in the embodiments of FIG. 5 and thus is marked as a block with dotted lines in FIG. 5.

In an embodiment of operation 560, the execution condition for the target SCG includes a time range, e.g., from abstract time T1 to abstract time T2 which may absolute UTC time. Once the execution condition for the target MCG is met, UE 501 begins to determine whether “a time point when UE 501 determines whether the execution condition for the target SCG is fulfilled” (i.e., the current time) is within the time range (e.g., from abstract time T1 to abstract time T2). If the current time is within the time range, UE 501 may determine that the execution condition for the target SCG is fulfilled.

In another embodiment of operation 560, the execution condition for the target SCG includes a time threshold (e.g., abstract time T3 which may absolute UTC time) and a configuration regarding a timer (e.g., a length of the timer). The UE starts the timer at time of the time threshold. If the timer is still running at “a time point when UE 501 determines whether the execution condition for the target SCG is fulfilled”, UE 501 may determine that the execution condition for the target SCG is fulfilled. In operation 560, UE 501 may determine that the execution condition for the target MCG is fulfilled. Then, in operation 570, the UE may perform a RA procedure to target MN 503. In operation 560, the UE may determine that the execution condition for the target SCG is fulfilled. Then, in operation 580, the UE may perform a RA procedure to target SN 504. The sequences of operations 570 and 580 are not fixed and may be varied in different embodiments.

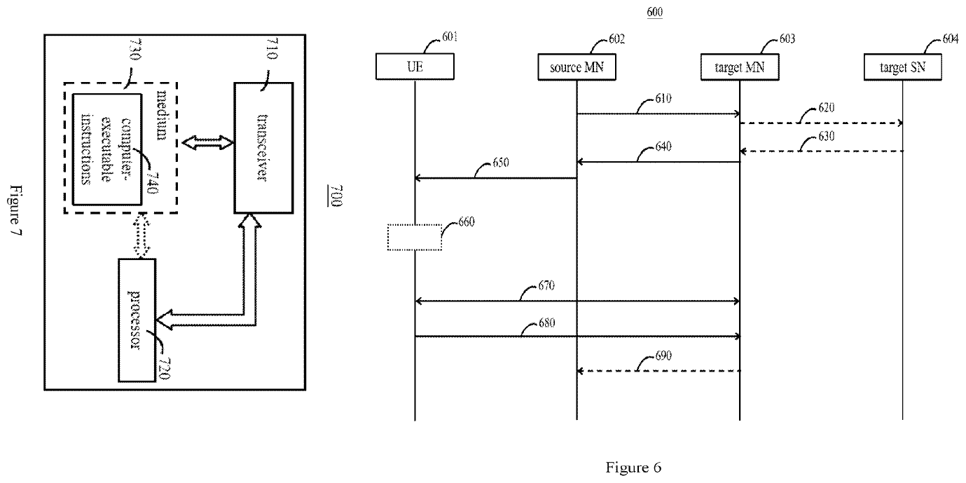

FIG. 6 illustrates an exemplary signaling flow chart 600 according to some embodiments of the present disclosure. It would be appreciated that for simplification and concise, FIG. 6 only illustrates necessary signaling according to some embodiments of the present disclosure, and the present disclosure is not limited to the exemplary flow chart 600. In the embodiments of FIG. 6, the wireless communication system supports DC or non-standalone (NSA) mode.

In the embodiments of FIG. 6, UE 601 in an RRC connected state accesses its serving BS, e.g., source MN 602. UE 601 may report measurement results to source MN 602. Based on the received measurement results, source MN 602 may determine to switch UE 601 to target MN 603 via CHO including SCG. For example, source MN 602 may prepare an execution condition for the target MCG.

In operation 610, source MN 602 transmits a handover request message to target MN 603. The handover request message may indicate target MN 603 to prepare a target SCG, e.g., target SN 604.

In some embodiments, after reception of the handover request message, target MN 603 may prepare configuration information for the target MCG. In an embodiment, in operation 620, target MN 603 transmits a request message (e.g., SgNB Addition Request or SN Modification request message) to target SN 604, e.g., via Xn interface, and in operation 630, target SN 604 transmits configuration information for the target SCG to target MN 603 via an acknowledge message (e.g., SgNB Addition Request Acknowledge or SgNB modification Request Acknowledge).

In some embodiments, target MN 603 prepares the execution condition for the target SCG. In an embodiment, in operation 620, target MN 603 transmits a request message (e.g., SgNB Addition Request or SN Modification request message) to target SN 604, e.g., via Xn interface, and in operation 630, target SN 604 transmits the execution condition for the target SCG to target MN 603 via an acknowledge message (e.g., SgNB Addition Request Acknowledge or SgNB modification Request Acknowledge).

In some embodiments, if the CHO Information SN Addition IE is included in the request message in operation 620, target SN 604 shall consider that the SN (S-NG-RAN node) Addition Preparation procedure has been triggered as part of a conditional handover. It may use the Source M-NG-RAN node ID IE and the Source M-NG-RAN node UE XnAP ID IE to identify other active S-NG-RAN node Addition Preparations related to UE 601.

In some embodiments, if the Estimated Arrival Probability IE is contained in the CHO Information SN Addition IE included in the request message in operation 620, the S-NG-RAN node may use the information to allocate necessary resources for UE 601.

The operation 620 and 630 are optional in the embodiments of FIG. 6 and thus are marked as dotted lines in FIG. 6.

Then, in operation 640, target MN 603 transmits a handover request acknowledge message to source MN 602, e.g., via Xn interface. The handover request acknowledge message includes a CHO configuration for the target MCG and the target SCG. The CHO configuration for the target MCG and the target SCG include configuration information for the target MCG and configuration information for the target SCG.

In some embodiments, the handover request acknowledge message in operation 640 includes an execution condition for the target SCG. The execution condition for the target SCG may be generated by target MN 603 or received from target SN 604. That is, in these embodiments, target MN 503 configures the execution condition for the target SCG together with CHO configuration. When UE 601 receives CHO including the target SCG, UE 601 is expected to decode the CHO command. For instance, the execution condition for the target SCG could be S-criteria, conditional event A3 or A5, a time range, and/or a time threshold and a configuration regarding a timer as described above in any of the embodiments of FIGS. 1-4.

in some other embodiments, the handover request acknowledge message in operation 640 includes an indicator indicating that the CHO configuration includes configuration information for the target SCG, e.g., RRC configuration information for the target SCG. This indicator may be used to indicate source MN 602 to configure the execution condition for the target SCG. That is, in these embodiments, source MN 602 configures the execution condition for the target SCG. One explicit indication is added in the handover request acknowledge message in operation 640, to indicate that SCG is added in RRC reconfiguration for CHO.

Then in operation 650, source MN 602 transmits at least one of the CHO configuration for the target MCG and the target SCG, the execution condition for the target MCG, or the execution condition for the target SCG to UE 601 e.g., via an RRC reconfiguration message for CHO including SCG. The execution condition for the target SCG is received from target MN 603 or is generated by source MN 602 itself.

Then, in operation 660, UE 601 begins to evaluate the execution condition for the target MCG and the execution condition for the target SCG, and determines whether the execution condition for the target MCG and the execution condition for the target SCG are fulfilled. The present disclosure has provided various methods and embodiments regarding how and when to evaluate the execution condition for the target MCG and/or the execution condition for the target SCG, and regarding determining whether the execution condition for the target MCG and/or the execution condition for the target SCG is fulfilled, e.g., in any of the embodiments of FIGS. 1-4.

For example, in operation 660, UE 601 may evaluate the execution condition for the target MCG when receiving the RRC reconfiguration message for CHO including SCG. Similar to operation 560 in the embodiments of FIG. 5, operation 660 is optional in the embodiments of FIG. 6 and thus is marked as a block with dotted lines in FIG. 6.

For instance, similar to the details described in operation 560 in the embodiments of FIG. 5, in an embodiment of operation 660, the execution condition for the target SCG includes a time range, and once the execution condition for the target MCG is met, if “a time point when UE 601 determines whether the execution condition for the target SCG is fulfilled” is within the time range, UE 601 may determine that the execution condition for the target SCG is fulfilled.

Similar to the details described in operation 560 in the embodiments of FIG. 5, in another embodiment of operation 660, the execution condition for the target SCG includes a time threshold and a configuration regarding a timer. UE 601 may start the timer at time of the time threshold. If the timer is still running at “a time point when UE 601 determines whether the execution condition for the target SCG is fulfilled”, UE 601 may determine that the execution condition for the target SCG is fulfilled.

In a further embodiment of operation 660, once the execution condition for the target MCG is met, UE 601 begins to evaluate the execution condition for the target SCG. Namely, UE 601 begins to evaluate the SCG condition when UE 601 performs a RA procedure towards the target PCell.

In an additional embodiment of operation 660, when the entry condition of the execution condition for the target MCG is met, UE 601 begins to evaluate the execution condition for the target SCG. When the leaving condition of the execution condition for the target MCG is met, UE 601 stops evaluating the execution condition for the target SCG.

In some embodiments, two events are configured for CHO. UE 601 begins to evaluate the execution condition for the target SCG, when the entry condition of one event (e.g., event #1) is met, or when the entry condition of the other event (e.g., event #2) is met while the entry condition of event #1 is also met. When leaving conditions of these two events are met, UE 601 may stop evaluating the execution condition for target SCG.

In yet an additional embodiments of operation 660, UE 601 evaluate both the execution condition for the target MCG and the execution condition for the target SCG upon receiving the RRC reconfiguration message for CHO including SCG.

In another embodiment of operation 660, when UE 601 completes a RA towards the PCell, i.e., target MN 603 (e.g., in operation 670), UE 601 determines whether the execution condition for the target SCG is met.

In yet another embodiment of operation 660, when the execution of the CHO procedure to target MN 603, is completed, UE 601 determines whether the execution condition for the target SCG is met.

In yet another embodiment of operation 660, UE 601 determines whether the execution condition for the target SCG is met during time duration between triggering the RA towards target MN 603 and completing a RA towards target MN 603.

In some embodiments, in operation 660, UE 601 may determine that the execution condition for the target MCG is fulfilled while the execution condition for the target SCG is unfulfilled. Then, in operation 670, UE 601 performs a RA procedure to target MN 603, and in operation 680, UE 601 reports failure information to target MN 603.

For instance, in an embodiment, when UE 601 completes the RA towards target MN 603 and the execution condition for the target SCG is not met, UE 601 will inform target MN 603 via an RRC reconfiguration complete message. Namely, failure information may be included in the RRC reconfiguration complete message. For example, the failure information may indicate that the execution condition for the target SCG is not met.

In another embodiment, when UE 601 completes the RA towards target MN 603 and the execution condition for the target SCG is not met, UE 601 may trigger an SCG failure information message. The failure information may be included in the SCG failure information message. The failure information may indicate that the execution condition for the target SCG is not met.

In some embodiments, in operation 690, target MN 603 may forward the received failure information to source MN 602, e.g., to enhance MRO function of the wireless communication system. Operation 690 is optional in the embodiments of FIG. 6 and thus is marked as dotted lines in FIG. 6.

It is contemplated that details described in all other embodiments (e.g., regarding how and when to evaluate the execution condition for the target SCG, and regarding determining whether the execution condition for the target SCG is fulfilled) of the present application are applicable for the embodiments of FIG. 5 and FIG. 6.

FIG. 7 illustrates a simplified block diagram of an exemplary apparatus 700 according to some embodiments of the present disclosure. In some embodiments, apparatus 700 may be or include at least a part of a UE (e.g., UE 501, UE 601) or similar device having similar functionality. In some other embodiments, apparatus 700 may be or include at least a part of a source MN (e.g., source MN 502, source MN 602) or similar device that can use the technology of the present disclosure. In some other embodiments, apparatus 700 may be or include at least a part of a target MN (e.g., target MN 503, target MN 603) or similar device that can use the technology of the present disclosure. In some other embodiments, apparatus 700 may be or include at least a part of a target SN (e.g., target SN 504, target SN 604) or similar device that can use the technology of the present disclosure.

As shown in FIG. 7, apparatus 700 may include at least transceiver 710 and processor 720, and transceiver 710 may be coupled to processor 720. Furthermore, apparatus 700 may include non-transitory computer-readable medium 730 with computer-executable instructions 740 stored thereon, wherein non-transitory computer-readable medium 730 may be coupled to processor 720, and computer-executable instructions 740 may be configured to be executable by processor 720. In some embodiments, transceiver 710, non-transitory computer-readable medium 730, and processor 720 may be coupled to each other via one or more local buses.

Although in FIG. 7, elements such as transceiver 710, non-transitory computer-readable medium 730, and processor 720 are described in the singular, the plural is contemplated unless limitation to the singular is explicitly stated. In some embodiments of the present disclosure, the transceiver 710 may be configured for wireless communication. In some embodiments of the present disclosure, transceiver 710 can be integrated into a transceiver. In certain embodiments of the present disclosure, the apparatus 700 may further include other components for actual usage.

According to some embodiment of the present disclosure, apparatus 700 is a UE or at least a part of a UE (e.g., UE 501, UE 601). Processor 720 is configured to cause the apparatus 700 at least to perform, with transceiver 710, any method (e.g., method 100) described above which is performed by a UE according to the present disclosure.

For instance, in some embodiments, processor 720 of a UE may be configured to, via transceiver 710, receive at least one of: a CHO configuration for a target MCG and a target SCG, an execution condition for the target MCG, or an execution condition for the target SCG; and perform a RA procedure to the target MCG in response to fulfillment of at least the execution condition for the target MCG.

According to some embodiment of the present disclosure, apparatus 700 is a source MN (e.g., source MN 502, source MN 602) or at least a part of a source MN that can use the technology of the present disclosure. Processor 720 is configured to cause the apparatus 700 at least to perform, with transceiver 710, any method (e.g., method 200) described above which is performed by a source MN according to the present disclosure.

For instance, in some embodiments, processor 720 of a source MN may be configured to, via transceiver 710, transmit a handover request message to a target MN; receive a handover request acknowledge message from the target MN, wherein the handover request acknowledge message includes a CHO configuration for a target MCG and a target SCG; and transmit, to a UE, at least one of: the CHO configuration for the target MCG and the target SCG, an execution condition for the target MCG, or an execution condition for the target SCG.

According to some embodiment of the present disclosure, apparatus 700 is a target MN (e.g., target MN 503, target MN 603) or at least a part of a target MN that can use the technology of the present disclosure. Processor 720 is configured to cause the apparatus 700 at least to perform, with transceiver 710, any method (e.g., method 300) described above which is performed by a target MN according to the present disclosure.

For instance, in some embodiments, processor 720 of a target MN may be configured to, via transceiver 710, receive a handover request message from a source MN; and transmit a handover request acknowledge message to the source MN, wherein the handover request acknowledge message includes a CHO configuration for a target MCG and a target SCG.

According to some embodiment of the present disclosure, apparatus 700 is a target SN (e.g., target SN 504, target SN 604) or at least a part of a target SN that can use the technology of the present disclosure. Processor 720 is configured to cause the apparatus 700 at least to perform, with transceiver 710, any method (e.g., method 400) described above which is performed by a target SN according to the present disclosure.

For instance, in some embodiments, processor 720 of a target SN may be configured to, via transceiver 710, receive a request message from a target MN; and transmit an acknowledge message to the target MN, wherein the acknowledge message includes configuration information for a target SCG, e.g., RRC configuration information for the target SCG.

In various example embodiments, processor 720 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processor 720 may also include at least one other circuitry or element not shown in FIG. 7.

In various example embodiments, non-transitory computer-readable medium 730 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable medium 730 may include, but is not limited to, an electric, a magnetic, an optical, an electromagnetic, an infrared, or a semiconductor system, apparatus, or device or any combination of the above.

Further, in various example embodiments, exemplary apparatus 700 may also include at least one other circuitry, element, and interface, for example antenna element, and the like.

In various example embodiments, the circuitries, parts, elements, and interfaces in exemplary apparatus 700, including processor 720 and non-transitory computer-readable medium 730, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive at least one of: a conditional handover (CHO) configuration for a target master cell group (MCG) and a target secondary cell group (SCG), a first execution condition for the target MCG, or a second execution condition for the target SCG; and
perform a random access (RA) procedure to the target MCG in response to fulfillment of at least the first execution condition.

2. The UE of claim 1, wherein the first execution condition for the target MCG includes at least one of:
a channel quality threshold, wherein the first execution condition is considered as fulfilled if channel quality is greater than or equal to the channel quality threshold;
one conditional event; or
a combination of two conditional events.

3. The UE of claim 2, wherein the first execution condition for the target MCG includes the combination of the two conditional events, and wherein the at least one processor is configured to cause the UE to start to evaluate the second execution condition for the target SCG:
in response to fulfillment of an entry condition of a first event of the two conditional events; or
in response to fulfillment of an entry condition of each of the two conditional events.

4. The UE of claim 2, wherein the first execution condition for the target MCG includes the combination of the two conditional events, and wherein the at least one processor is configured to cause the UE to stop evaluating the second execution condition for the target SCG:
in response to fulfillment of a leaving condition of a first event of the two conditional events; or
in response to fulfillment of a leaving condition of each of the two conditional events.

5. The UE of claim 1, wherein the second execution condition for the target SCG includes at least one of:
a channel quality threshold, wherein the second execution condition for the target SCG is considered as fulfilled if channel quality is greater than or equal to the channel quality threshold;
one conditional event;
a combination of two conditional events;
a time range, wherein the time range includes a first absolute time and a second absolute time; or
a time threshold and a configuration regarding a timer, wherein the time threshold is a third absolute time.

6. The UE of claim 1, wherein the at least one processor is configured to cause the UE to:
start to evaluate the second execution condition for the target SCG in response to fulfillment of the first execution condition for the target MCG; or
start to evaluate the second execution condition for the target SCG in response to fulfillment of an entry condition of the first execution condition for the target MCG; or
start to evaluate both the first execution condition for the target MCG and the second execution condition for the target SCG when both the first execution condition for the target MCG and the second execution condition for the target SCG are received.

7. The UE of claim 6, wherein the at least one processor is configured to cause the UE to stop evaluating the second execution condition for the target SCG in response to un-fulfillment of the first execution condition for the target MCG or in response to fulfillment of a leaving condition of the first execution condition for the target MCG.

8. The UE of claim 1, wherein the at least one processor is configured to cause the UE to determine whether the second execution condition for the target SCG is fulfilled:
upon completing the RA procedure to the target MCG; or
in response to fulfillment of the first execution condition for the target MCG; or
in a time duration between triggering the RA procedure to the target MCG and completing the RA procedure to the target MCG.

9. The UE of claim 5, wherein the second execution condition for the target SCG includes the time range, and wherein the at least one processor is configured to cause the UE to determine that the second execution condition for the target SCG is fulfilled if a time point when the at least one processor causes the UE to determine whether the second execution condition is fulfilled is within the time range.

10. The UE of claim 5, wherein the second execution condition for the target SCG includes the time threshold and the configuration regarding the timer, and wherein the at least one processor is configured to cause the UE to:
start the timer at time of the time threshold; and
determine that the second execution condition for the target SCG is fulfilled if the timer is running at a time point when the at least one processor causes the UE to determine whether the second execution condition is fulfilled.

11. The UE of claim 1, wherein the at least one processor is configured to cause the UE to:
start a mobility timer upon starting to perform the RA procedure to the target MCG and stop the mobility timer upon completing the RA procedure; or
in response to fulfillment of both the first execution condition for the target MCG and the second execution condition for the target SCG, perform a RA procedure to the target SCG.

12. The UE of claim 1, wherein in response to un-fulfillment of the second execution condition, the at least one processor is configured to cause the UE to:
transmit, a message including failure information to a target master node (MN); or
trigger an SCG failure information procedure.

13. The UE of claim 12, wherein the SCG failure information procedure is triggered after completing the RA procedure to the target MCG or a mobility timer is stopped.

14. The UE of claim 12, wherein the failure information is included in a radio resource control (RRC) reconfiguration complete message or a SCG failure information message, and wherein the failure information indicates that the second execution condition for the target SCG is not fulfilled.

15. A source master node (MN) for wireless communication, comprising:
at least one memory; and
at least one processor coupled with the at least one memory and configured to cause the MN to:
transmit a handover request message to a target MN;
receive a handover request acknowledge message from the target MN, wherein the handover request acknowledge message includes a conditional handover (CHO) configuration for a target master cell group (MCG) and a target secondary cell group (SCG); and
transmit, to a user equipment (UE), at least one of: the CHO configuration for the target MCG and the target SCG, a first execution condition for the target MCG, or a second execution condition for the target SCG.

16. The source MN of claim 15, wherein the handover request acknowledge message includes an indicator indicating that the CHO configuration includes configuration information for the target SCG.

17. The source MN of claim 15, wherein the handover request acknowledge message includes the second execution condition for the target SCG.

18. A processor for wireless communication, comprising:
at least one controller coupled with at least one memory and configured to cause the processor to:
receive at least one of: a conditional handover (CHO) configuration for a target master cell group (MCG) and a target secondary cell group (SCG), a first execution condition for the target MCG, or a second execution condition for the target SCG; and
perform a random access (RA) procedure to the target MCG in response to fulfillment of at least the first execution condition.

19. The processor of claim 18, wherein the at least one controller is configured to cause the processor to:
start a mobility timer upon starting to perform the RA procedure to the target MCG and stop the mobility timer upon completing the RA procedure; or
in response to fulfillment of both the first execution condition for the target MCG and the second execution condition for the target SCG, perform a RA procedure to the target SCG.

20. A method performed by a user equipment (UE), the method comprising:
receiving at least one of: a conditional handover (CHO) configuration for a target master cell group (MCG) and a target secondary cell group (SCG), a first execution condition for the target MCG, or a second execution condition for the target SCG; and
performing a random access (RA) procedure to the target MCG in response to fulfillment of at least the first execution condition.
